(19) United States
(12) Patent Application Publication
(10) Pub. No.: US 2018/0355947 A1
(43) Pub. Date: Dec. 13, 2018

(54) FRICTION SHOCK ABSORBER

(71) Applicant: Aleh Nicolaevich Halavach, Bobruisk (BY)

(72) Inventor: Aleh Nicolaevich Halavach, Bobruisk (BY)

(21) Appl. No.: 15/779,728

(22) PCT Filed: Jan. 20, 2017
(86) PCT No.: PCT/BY2017/000002

§ 371 Date: May 29, 2018

(30) Foreign Application Priority Data
Feb. 22, 2016 (EA) 2016/EA/0014

(51) Int. Cl. F16F 13/00; F16F 13/04; F16F 7/08

(52) U.S. Cl. CPC F16F 13/005; B61G 11/14; F16F 7/08; F16F 13/04

(57) ABSTRACT

The invention relates to the field of vehicle engineering and concerns friction shock absorbers for vehicles, primarily rolling stock. The aim of the invention is to increase the reliability and operating efficiency of a friction shock absorber. The present friction shock absorber (FIG. 3) comprises a housing (1), having a bottom (4) and a neck (2), which is formed by the walls (3) of the housing, said neck having disposed therein a return and retaining device (5) which can be compressed and which contacts with a friction assembly (7) consisting of a pressure wedge (10) and stay wedges (11) in contact therewith. In the neck (2) of the housing (1) there are arranged guide plates (12), which are in contact with the stay wedges (11) as well as with movable plates (13), the latter being in contact with the walls (3) of the housing (1) and being provided with protuberances (9), between which are disposed the guide plates (12), which are mounted on internal protuberances (20) in the housing (1). The surfaces of the guide plates (12) facing the stay wedges (11) have recesses (V) provided therealong, which encompass the return and retaining device (5).

The invention relates to the field of vehicle engineering and concerns friction shock absorbers for vehicles, primarily shock-absorbing devices, installed between cars of a railway train.

A friction shock absorber is known in the art [1, U.S. Pat. No. 2,701,063, IPC B61G9/1Q, priority date 28 Nov. 1951, publication date 1 Feb. 1955], which comprises wedges arranged in the housing, said wedges pressing plate stacks to the housing, said plate stacks consisting of guide plates and a movable plate, arranged between said guide plates, wherein one of the guide plates in the plate stacks is arranged between the housing and the movable plate, and the other one—between the movable plate and one of the wedges.

Such friction assembly has low energy intensity, as the force, which is generated at the side of its pressure wedge, and which presses the wedges to the movable plates and the guide plates, is low. The resulting friction force is insufficient to achieve high energy absorption. The lack of efficiency is due to the fact that the return and retaining device occupies space under the friction assembly only, and it is impossible to arrange springs with higher pressure inside devices with the existing dimensions; therefore, the efficiency of such devices is relatively low.

Said problem is solved by the prior art device [2, RU 2380257, IPC B61G9/18, priority date 13 Nov. 2007, publication date 20 May 2009).

It comprises a housing having a neck formed by its walls, and a bottom, whereon a return and retaining device is arranged which can be compressed and which contacts with the friction assembly, which consists of a pressure wedge and stay wedges in contact therewith. In the neck of the housing, guide plates are arranged, said guide plates being mounted on internal protuberances of the housing and in contact with the stay wedges as well as with movable plates, the latter being in contact with the walls of the housing.

In order to increase the efficiency of the friction shock absorber [2] protuberances on the movable plates are provided, said protuberances being in contact with the supporting plate. The guide plates are arranged between such protuberances. In this case, each movable plate rests on the supporting plate with its lateral protuberances and not with its lower end, as provided for by the similar design [1]; thus, the height of the return and retaining device may be increased, and, consequently, higher stiffness of the return and retaining device as well as higher efficiency of the entire device may be ensured. Whereby the thrust force and energy absorption in the friction assembly is increased while preserving the same dimensions. The guide plates are provided with long friction surfaces, which ensure high energy absorption during friction.

The length of the friction surfaces and their tight contact with the stay wedges result in the force development at the end of the compression stroke of the return and retaining device due to the frictional energy. In many cases, it may lead to the sharp increase of the end force when the friction shock absorber is closed, which results in its inoperability. Therefore, increase of the space between the bottom of the housing and the friction assembly does not allow for its use with full efficiency for installation of the high-stiffness return and retaining device.

In order to achieve optimal results, a return and retaining device with maximal possible stiffness must be used, but the end force at the close of the shock absorber must be limited. It is necessary to obtain the required characteristics of the friction shock absorber, which do not exceed the standard values, and to achieve high initial clamping load and maximal load bearing characteristics, which correspond to the high energy intensity of the device. The prior art design [2] does not demonstrate such required solution.

The foregoing disadvantages of the prior art friction shock absorber [2] reduce its operational reliability and efficiency.

Thus, the object of the invention is to achieve a technical result aiming at increase of reliability and operating efficiency of the friction shock absorber by installing a high-stiffness return and retaining device and by reducing the end stress of the friction shock absorber when the return and retaining device is compressed.

Said object is achieved by a friction shock absorber, comprising a housing having a bottom and a neck, which is formed by the walls of the housing, said neck having a return and retaining device disposed therein, which can be compressed and which contacts with a friction assembly, consisting of a pressure wedge and stay wedges in contact therewith, also, guide plates are arranged in the neck of the housing, said guide plates being in contact with the stay wedges and with movable plates, said movable plates being in contact with the walls of the housing and being provided with protuberances, between which the guide plates are disposed, which are mounted on internal protuberances in the housing, wherein said friction shock absorber has the following characteristic features: the surfaces of the guide plates facing the stay wedges have recesses provided therealong, which encompass the return and retaining device.

This feature allows use of a high-stiffness return and retaining device, thus increasing its initial clamping load. As the result of minimization of the frictional energy effect (due to the reduction of area and length of sections where the stay wedges are in full contact with the guide plates) at the end of the compression stroke of the return and retaining device, high energy intensity of the friction shock absorber may be ensured and the excess force development during compression of the return and retaining device may be limited.

Additional characteristic features:

recesses in the guide plates have a curved shape and occupy only a part of the width of the guide plates;

the distance from the bottom ends of the guide plates to the neck ends of the recesses in the guide plates exceeds one half of their length;

hitches are provided in the walls of the housing with notches made between them;

the walls of the housing are also formed by inserts, arranged in contact with the movable plates;

the pressure wedge is fixed inside the housing by means of hitches, locked in the hitches in the walls of the housing.

The invention is further described in detail with reference to the accompanying figures, wherein:

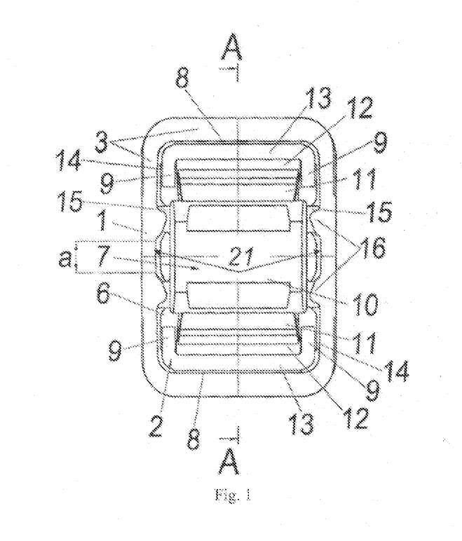

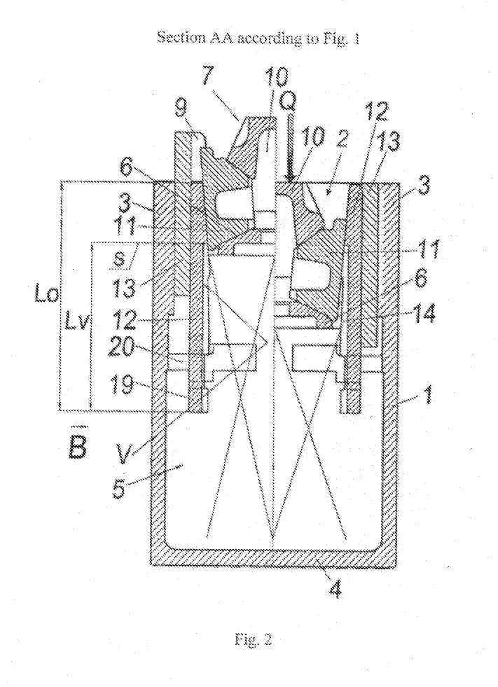

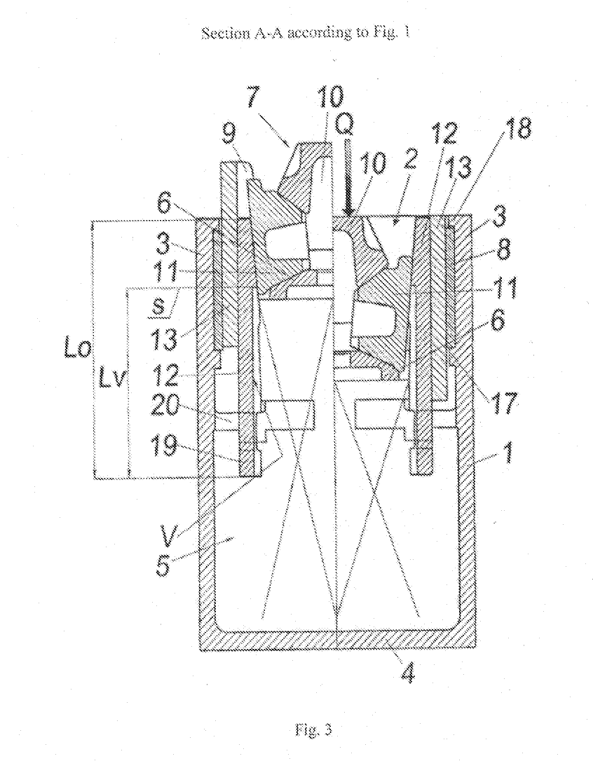

FIG. 1 shows the top view of the friction shock absorber;

FIGS. 2 and 3 show combined longitudinal section A-A according to FIG. 1, wherein the left part shows the friction shock absorber in the initial position, and the right part shows the friction shock absorber in fully compressed position;

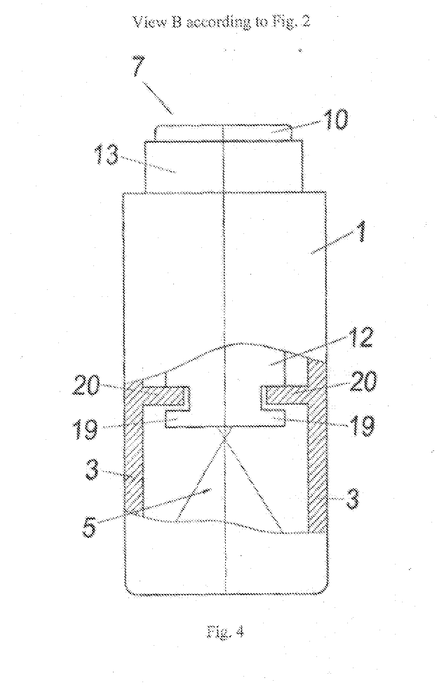

FIG. 4 shows view B with a broken-out section according to FIG. 2;

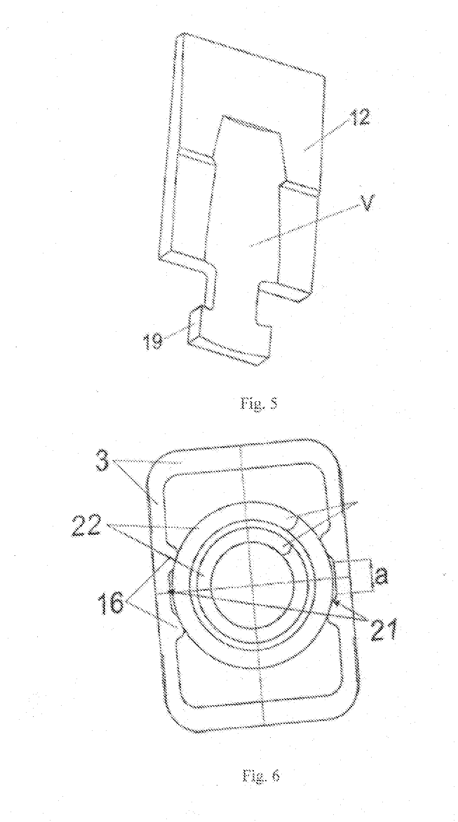

FIG. 5 shows a guide plate of the friction shock absorber according to the utility model;

FIG. 6 shows the housing of the friction shock absorber with the return and retaining device inside, the said device having the form of a stack of metal springs installed into each other.

The friction shock absorber (FIG. 1-3), comprises a housing 1, having a neck 2, formed by the walls 3 and the bottom 4 of the housing. A return and retaining device 5 is arranged in the neck 2, said return and retaining device being contacted to a friction assembly 7 either directly (not shown) or via a supporting plate 6.

Walls 3 of the housing 1 may also be formed by inserts 8 (FIG. 3).

The return and retaining device 5 may be of a spring type (FIG. 6) or it may be designed as a stack of resilient and elastic elements (not shown).

The friction assembly 7 (FIG. 1-3) consists of a pressure wedge 10 and stay wedges 11 in contact therewith. In the neck 2 of the housing 1, guide plates 12 are arranged, said guide plates having recesses V (FIG. 2, 3, 5), which face the stay wedges 11. Said recesses V are arranged along the guide plates and encompass the return and retaining device 5. The recesses V (FIG. 5) in the guide plates 12 have a curved shape and occupy only a part of the width of the guide plates.

Whereas the guide plates 12 (FIG. 1-3) are arranged in contact with said stay wedges 11 and said movable plates 13, which have said protuberances 9 and which are arranged between the walls 3 of the housing 1 and in contact therewith (FIG. 2). In order to ensure high wear resistance of the walls 3 of the housing 1, inserts 8 are preferably installed between the walls 3 and the movable plates 13 (FIG. 1, 3).

The supporting plate 6 has protuberances 14 (FIG. 1), designed to engage with the protuberances 9 of the movable plates 13 during the return stroke of the friction assembly 7. The pressure wedge 10 is provided with hitches 15 for fixing, and the walls 3 of the housing 1 are provided with hitches 16.
The walls 3 of the housing 1 are also provided with support protuberances 17, whereon the inserts 8 are supported (FIG. 3); their movement is limited by fixing protuberances 18, which are also arranged in the walls 3 of the housing 1. Said recesses V (FIG. 2, 3, 5) in the guide plates 12 may be located, e.g., in the interval starting from the ends of the guide plates that are located closer to the bottom 4 of the housing 1, said recesses being directed to the neck 2 of the housing 1; furthermore, said recesses may be located in such a manner that the distances Lv from the ends of the guide plates 12 to the ends s of the recesses V located closer to the neck 2 of the housing 1 exceed one half of the length Lo of the guide plates 12.

It facilitates decrease of force development intensity at the end of the compression stroke of the return and retaining device 5 as the result of minimization of the frictional energy effect in the friction assembly, due to the reduction of length of sections where the stay wedges 11 are in full contact with the guide plates 12.

To simplify the design of the middle part of the housing 1, it is desirable that the guide plates 12 (FIG. 2-5) have T-shapes return stroke stoppers 19, arranged closer to the bottom 4 of the housing 1 behind its internal protuberances 20.

In the walls 3 of the housing 1 between their hitches 16 (FIGS. 1 and 6) notches 21 are provided, having, e.g. a rectangular shape and width a, or an arc shape (not shown), so that, e.g. large-sized resilient and elastic elements or metal pressure springs 22 with a larger diameter may be used in the return and retaining device 5 (in case it has the form of a stack of resilient and elastic elements (not shown), or the form of a stack of metal pressure springs 22 installed into each other (FIG. 6)), in order to increase the energy intensity of the friction shock absorber.

The operating principle of the friction shock absorber is based on the fact that the return and retaining device 5 is compressed when external force Q is applied to the pressure wedge 10, e.g. at the side of the drawbar, when the cars collide.

In this case the friction assembly 7 operates as follows. The pressure wedge 10 brings the stay wedges 11 inside the housing 1. At a certain phase of the stroke, the pressure plate (not shown) of the automatic coupling device of the car starts to press on the movable plates 13. When exposed to this force, the movable plates 13 move inside the housing 1 frictionally along the guide plates 12 and walls 3 of the housing 1 (FIG. 2), or along the guide plates 12 and inserts 8 (FIG. 3). Due to the degree of taper of the guide plates 12, the stay wedges 11 move to the inside and to the axis of the shock absorber, gliding along the guide plates 12, and along the friction surfaces of the pressure wedge 11 and the supporting plate 6. Moreover, at the very end of the stroke of the shock absorber, the thrust force builds up (due to the high-elastic return and retaining device 5) to such extent, that the frictional energy causes sharp increase of the end stress at the close of the friction shock absorber, when the stay wedges 11 move along the guide plates 12. However, according to the design of the utility model, at the very end of the stroke, the stay wedges 11 contact with the guide plates 12 on a smaller surface due to the recesses V; moreover, the length of sections where the stay wedges 11 are in full contact with the guide plates 12 is reduced, consequently, the frictional energy effect on the end stress increase is reduced as well.

When site external force applied to the shock absorber is removed, the return and retaining device 5 is extended and pushes out the supporting plate 6 with the installed stay wedges 11 and the pressure wedge 10. At a certain phase of the reverse stroke, the protuberances 14 (FIG. 1) of the supporting plate 6 are engaged with the protuberances 9 of the movable plates 13, and the device is brought to the initial position till the hitches 15 on the pressure wedge 10 are stopped by the hitches 16 of the housing 1 (FIG. 1).

Notches 21 (FIG. 1 [symbol] 6) between the hitches 16 of the housing 1, as well as recesses V on the guide plates 12 allow for installation of the return and retaining device with the maximal diameter, whether the device has the form of a stack of metal pressure springs 22 installed into each other (FIG. 6) or the form of a stack of resilient and elastic elements.

### INFORMATION SOURCES

1. Patent U.S. Pat. No. 2,701,063, IPC B61G9/10, priority date 28 Nov. 1951, publication date 1 Feb. 1955.
2. Patent RU 2380257, IPC B61G9/18, priority date 13 Nov. 2007, publication date 20 May 2009/prior art/.

1. A friction shock absorber, comprising a housing (1) having a bottom (4) and a neck (2), which is formed by the walls (3) of the housing (1), said neck having a return and retaining device (5) disposed therein, which can be compressed and which contacts with a friction assembly (7), consisting of a pressure wedge (10) and stay wedges (11) in contact therewith, also, guide plates (12) are arranged in the neck (2) of the housing (1), said guide plates being in contact with the stay wedges (11) and with movable plates (13), said movable plates being in contact with the walls (3) of the housing (1) and being provided with protuberances (9), between which the guide plates (12) are disposed, which are mounted on internal protuberances (20) in the housing (1), wherein, the surfaces of the guide plates (12) facing the stay wedges (11) have recesses (V) provided therealong, which encompass the return and retaining device (5).

2. Shock absorber according to claim 1, wherein recesses (V) in the guide plates (12) have a curved shape and occupy only a part of the width of the guide plates.

3. Shock absorber according to claim 1, wherein the distance (Lv) from the ends of the guide plates (12), located closer to the bottom (4) of the housing (1), to the ends (s) of the recesses (V) in the guide plates (12), located closer to the neck (2) of the housing (1), exceeds one half of their length (Lo).

4. Shock absorber according to claim 1, wherein hitches (16) are provided in the walls (3) of the housing (1) with notches (21) made between them.

5. Shock absorber according to claim 1, wherein the walls (3) of the housing (1) are also formed by inserts (8), arranged in contact with the movable plates (13).

6. Shock absorber according to claim 4, wherein the pressure wedge (10) is fixed inside the housing (1) by means of hitches (15), locked in the hitches (16) in the walls (3) of the housing (1).
